(19) United States
(12) Patent Application Publication
(10) Pub. No.: US 2008/0126395 A1
(43) Pub. Date: May 29, 2008

(54) Automatically creating a relational database from a spreadsheet

(75) Inventor: Amichai Marueli, Ramat Hasharon (IL)

Correspondence Address: BRUX SOFTWARE SOLUTIONS LTD., 8 GORDON STREET, GIVATAYIM, 53235, omitted

(73) Assignee: OCYRHOE TECHNOLOGIES LTD

(21) Appl. No.: 11/604,816

(22) Filed: Nov. 28, 2006

(51) Int. Cl. G06F 17/30

(52) U.S. Cl. 707/102; 707/E17.045

(57) ABSTRACT

A method of creating a relational database schema from data represented in a matrix representation, comprising the steps of identifying dimensions of the matrix, said dimensions describing a multi-dimensional space; identifying hierarchies within said dimensions; identifying a data area of the matrix; calculating a set of coordinates within said multi-dimensional space for each data member in said data area; and mapping said dimensions into database tables.

### FIELD OF THE INVENTION

The present invention relates to automatic creation of databases schemas and specifically to the creation of a relational database schema from a matrix representation of data.

### BACKGROUND OF THE INVENTION

Data is often presented in worksheets, such as Excel spreadsheets, which are easy to comprehend and manipulate. But versatile as a spreadsheet is, it still cannot meet management demands for reliable, consolidated information—especially when the data is located in different countries or formats. When multiple users manipulate the data, it becomes unreliable. Consolidating data from many sources is time-consuming, complicated, and ridden with errors.

Various programs exist for saving spreadsheet data into databases, particularly relational databases. These programs have pre-knowledge of the spreadsheet structure and build the database schema accordingly.

US Published application No. 2005/0267853 to Netz et als provide a method for exposing and utilizing workbook ranges as server data sources, using editable metadata for the data objects.

US Published application No. 2005/0267899 to Gupta et al a method for loading tabular spreadsheet data into a pre-existing database.

There is need for a general-purpose application for creating a relational database schema, given any previously unknown spreadsheet wherein the data is arranged in a matrix representation.

### SUMMARY OF THE INVENTION

The current invention can automatically or semi-automatically create a database schema given one of several spreadsheet ‘structures’.

According to a first aspect of the present invention there is provided a method of creating a relational database schema from data represented in a matrix representation, comprising the steps of: identifying dimensions of the matrix, said dimensions describing a multi-dimensional space; identifying hierarchies within said dimensions; identifying a data area of the matrix; calculating a set of coordinates within said multi-dimensional space for each data member in said data area; and mapping said dimensions into database tables.

The step of identifying dimensions may be performed manually, whereby the data area is automatically identified.

Alternatively, the step of identifying a data area is performed manually, whereby the dimensions are automatically identified.

The dimensions may comprise at least one parameters area, at least one rows area and at least one columns area.

According to one embodiment the at least one rows area and/or the at least one columns area may comprise a plurality of rows and/or columns areas, whereby a hierarchy is automatically deduced.

The automatic deduction of hierarchy may be based on the distance of the rows and/or columns areas from the data area.

According to another embodiment empty cells of a dimension may be filled automatically.

According to yet another embodiment, the database tables represent a star schema.

According to another embodiment, the method of the present invention may additionally comprise the step of modifying at least one of said dimensions and said data, wherein said modifying automatically updates said database. The modifying may comprise at least one of the group consisting of: modifying a region extent, modifying a region name and modifying a data item value.

According to a second aspect of the present invention there is provided a system for creating a relational database schema from data represented in a matrix representation, comprising: means for identifying dimensions of the matrix, said dimensions describing a multi-dimensional space; means for identifying hierarchies within said dimensions; means for identifying a data area of the matrix; means for calculating a set of coordinates within said multi-dimensional space for each data member in said data area; and means for mapping said dimensions into database tables.

The means for identifying dimensions and/or the means for identifying data area may be user interface means.

The dimensions may comprise at least one parameters area, at least one rows area and at least one columns area.

According to one embodiment the at least one rows area and/or the at least one columns area may comprise a plurality of rows and/or columns areas

According to another embodiment the system comprises means for automatically filling empty cells of a dimension.

According to yet another embodiment, the database tables represent a star schema.

According to another embodiment, the system of the present invention may additionally comprise means for modifying at least one of said dimensions and said data, wherein said means for modifying automatically updates said database. The means for modifying may comprise at least one of the group consisting of: means for modifying a region extent, means for modifying a region name and means for modifying a data item value.

According to a third aspect of the present invention there is provided a computer-readable medium having computer-executable instructions stored thereon which, when executed by a computer, will cause the computer to perform the method of: creating a relational database schema from data represented in a matrix representation, comprising the steps of: identifying dimensions of the matrix, said dimensions describing a multi-dimensional space; identifying hierarchies within said dimensions; identifying a data area of the matrix; calculating a set of coordinates within said multi-dimensional space for each data member in said data area; and mapping said dimensions into database tables.

According to a fourth aspect of the present invention there is provided a computer-controlled apparatus capable of performing the method of: creating a relational database schema from data represented in a matrix representation, comprising the steps of: identifying dimensions of the matrix, said dimensions describing a multi-dimensional space; identifying hierarchies within said dimensions; identifying a data area of the matrix; calculating a set of coordinates within said multi-dimensional space for each data member in said data area; and mapping said dimensions into database tables.

### BRIEF DESCRIPTION OF THE DRAWINGS

For a better understanding of the invention and to show how the same may be carried into effect, reference will now be made, purely by way of example, to the accompanying drawings.

With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice. In the accompanying drawings:

FIGS. 1a and 1b are examples of data represented in a matrix representation;

FIG. 2 is an example of a spreadsheet wherein the matrix of FIG. 1 is represented;

FIGS. 3a and 3b exemplify filling empty dimension cells according to the present invention; and

FIG. 4 is the database representation of the spreadsheet of FIG. 2.

### DETAILED DESCRIPTION OF THE INVENTION

Before explaining at least one embodiment of the invention in detail, it is to be understood that the invention is not limited in its application to the details of construction and the arrangement of the components set forth in the following description or illustrated in the drawings. The invention is applicable to other embodiments or of being practiced or carried out in various ways. Also, it is to be understood that the phraseology and terminology employed herein is for the purpose of description and should not be regarded as limiting.

A matrix is a well known graphical representation of a two dimensional function. For example, FIG. 1a represents the sales increase (percent) in various countries for the year 2000 to 2002. The matrix contains two distinctive regions—the data region and the heading regions. In FIG. 1a, the shaded cell can be interpreted as the sales increase in Japan for the year 2001.

A two-dimensional matrix may represent a slice of a multidimensional cube. For example, FIG. 1a may represent the sales increase for the Cosmetics business unit within a company, while another two-dimensional matrix is required for other business units such as Food (FIG. 1b).

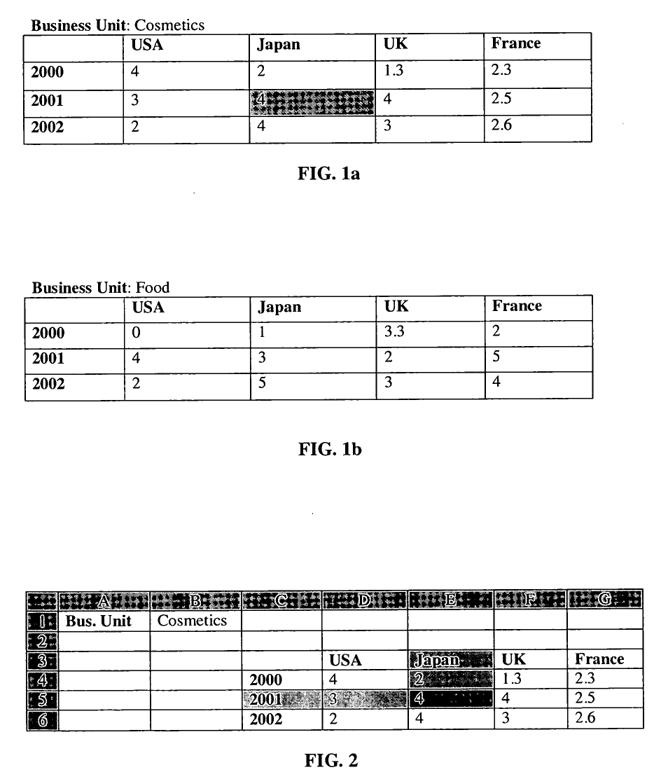

FIG. 2 depicts the representation of the matrix of FIG. 1a in a spreadsheet. Besides the matrix itself, the spreadsheet may contain additional information, in particular ‘parameters’ that apply to the entire matrix, such as the Business Unit.

A matrix can also be extended to support a hierarchy of dimensions in the row and columns regions. This is used, for example, in PivotTable representation. The current invention supports such hierarchies for user input.

In order to create a database schema for any given spreadsheet in which the data is represented as a matrix, the present invention needs first to map the various matrix dimensions.

In a matrix representation, the invention assumes the spreadsheet contains several areas, as exemplified in FIG. 2:

a parameters area A1:B1;

a rows area C4:C6;

a columns area D3:G3; and

a data items area D4:G6.

An area or region is a rectangular extent of cells within the spreadsheet. Excel uses a L:R notation for regions, where L is the upper left corner of the region and R is the lower-right corner. For example, C3:E4 is the region containing the six cells C3, C4, D3, D4, E3, and E4. The current invention allows for the parameters area to be a union of one or more regions.

The current invention requires a user to identify the parameters region and at least one of the data items region and the dimensions. It also requires that the rows region be either to the left or to the right of the data items region and that the columns region be either above or below the data items region.

Within the parameters region, the user is required to identify the dimension cells for the matrix. In FIG. 2, the only dimension cell in the parameters region is B1. A1 is the label of this dimension (Bus. Unit). Once the user picks B1 as a dimension cell, the contents of the cells to the left of or above the chosen cell may be suggested as the name of the dimension. In this case, the content of A1 would be suggested. The user can either accept the suggestion or override the automatic suggestion and use a different name for the dimension. This can be the name of a dimension that was previously created in the system or a new, unique, name for a new dimension.

To further assist the user, heuristics can be used to automatically identify the various regions. These heuristics may include: (a) searching for cells containing known representation of current members. For example, if the dimension ‘Country’ already exists in the system, and Japan, USA and France known as members of the dimension ‘Country’, then a row or a column containing Japan, USA, and France will be assumed to represent the dimension ‘Country’; (b) a heuristics can help finding the parameters area by looking for names of known dimensions and names of known members. If a dimension name is identified next to a known member of that dimension it is assumed to be part of the parameters area.

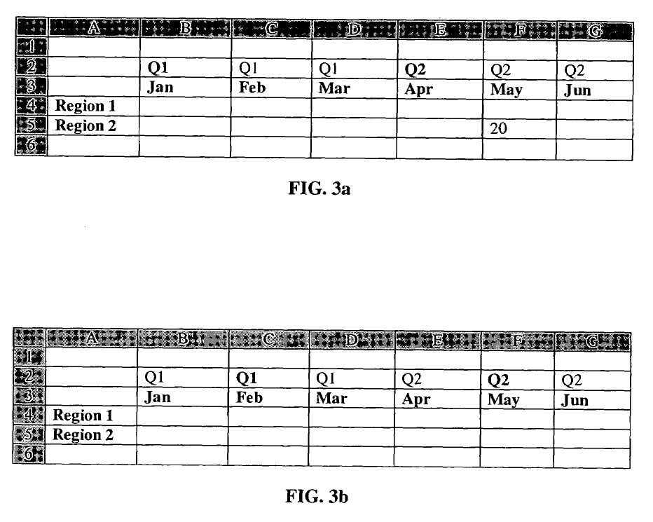

In the current invention, the rows area is represented by a single spreadsheet region that may span one or more columns, each column representing a single dimension. If the rows area includes more than one column, a hierarchy is assumed. Similarly, the columns area is a single region that may span several rows, one dimension per row. If the columns area includes more than one row, a hierarchy is assumed (FIG. 3a, rows 2 and 3).

Additional hierarchy can exist between the highest row or column dimension and a dimension in the parameters area. Notice that those relations are configured by the user.

Once the data items area is identified by the user, the rows and column area are automatically identified as including any non-empty regions lying immediately to the left or right and above or below the data items area. The user may correct this automatic identification. However, the current invention requires the columns spanned by the column region to correspond to the columns of the data-item region and for the rows spanned by the rows region to correspond to the rows of the data item. For example, in FIG. 2, once the user has identified D4:G6 as the data-items region, the rows region must be of the form x4:y6 where x and y are spreadsheet rows (the system would automatically suggest x=y=C in this example), and the column region must be of the form Dn:Gm (in this example, the system would suggest n=m=3).

Alternatively, the user may identify the rows and columns regions, and the data items area will be deduced from these regions: the data items area would be identified as the ‘product’ of the rows spanned by the rows area and the columns spanned by the columns area. In FIG. 2 if the user identifies the row region as C4:C6 and the column region as D3:G3 then the item region would be deduced as D4:G6.

Further, the user may mark one or more cells within the data items area as non-data, or alternatively select only part of the cells as actually containing data items. The content of the cells marked as non-data would not be considered as part of the data items area for the purpose of retrieving or storing data as described below and instead will be considered as part of the ‘template’. For example, if a cell included in the rectangle defined as data items area contains the term “Total”, it will not be considered and stored as a data item.

The system uses a heuristic to calculate the values of empty dimension cells, by looking at cells adjacent the empty cells. If the first cell for a dimension (e.g. for a row—the leftmost cell, for a column—the uppermost cell) is not empty, all empty cells of the dimension are assumed to ‘contain’ the first non-empty value to their left (for rows) or up (columns). For example, in FIG. 3a cells C2 and D2 are assumed to contain the value Q1 of the leftmost cell B2, and cells F2 and G2 are assumed to contain the value Q2 of cell E2. If the first cell is empty, and the full cells are located at equal distances, the value of an empty cell is determined by the closest full cell. For example, in FIG. 3b cells B2 and D2 are assumed to contain the value ‘Q1’ of the nearest cell C2, and cells E2 and G2 are assumed to contain the value ‘Q2’ of the nearest cell F2. In non-deterministic cases, where e.g. equal distances exist between a cell and two neighbors, a rule will be made as to which value to assume. In addition, the system may use indication such as borders, shading and coloring to deduce limits. For example, cells B2, C2, and D2 may be shaded blue while cells E2, F2, and G2 may be shaded red, indicating the value in C2 should not be extended across the shading ‘barrier’.

The process described above for assuming an empty dimension cell's content is only used for the purpose of carrying out the process of the present invention, and does not change the spreadsheet's contents.

Although dimension hierarchy cannot automatically be deduced from the spreadsheet structure, a system based on the current invention can provide reasonable suggestions for such a hierarchy, at least when limited to hierarchy between row-dimensions (dimensions in the row region) or column-dimensions. First, a direction is established. The direction determines the (assumed) relations between dimensions—a dimension A is ‘higher’ than dimension B if each member of A is a set of one or more members of B. For example, ‘Quarters’ can be considered higher than ‘Months’ as each quarter is a set of months—the 1^{st} Quarter is defined as the set of months containing January February, and March (FIG. 3).

The system uses a simple heuristic to determine a direction—the ‘farthest’ the dimension from the data items the higher it is in the hierarchy. For example, for row dimensions to the left of the data items region, left defines the ‘higher’ direction.

For each two adjacent dimensions in the rows or column region, the system uses a different heuristic to determine whether they are likely to be in a hierarchical relation. The system analyzes the members of each of the two dimensions, assuming that when the user identifies the rows and column regions, those regions contain valid data.

The system goes over the values at the lower dimension. For each value that appears at the lower dimension, all the different values in the corresponding higher dimension (rows—left, columns—up) are added to a set. If all of these sets are of size one, the heuristic assumes a hierarchy is present. Otherwise, the system determines a hierarchy is not present. This is because there is a containment relationship—each lower-level member is contained in exactly one higher dimension member (e.g. ‘January’ is in the 1st Quarter, and cannot appear in any other Quarter).

Once the dimensions are mapped, a relational database representation can be generated. In a preferred embodiment of the present invention a star schema is generated. A star schema is a relational schema whose design represents a multidimensional data model. The star schema consists of one or more data tables and one or more dimension tables. The star schema created in this stage comprises empty tables, one table for each dimension, and an empty data table.

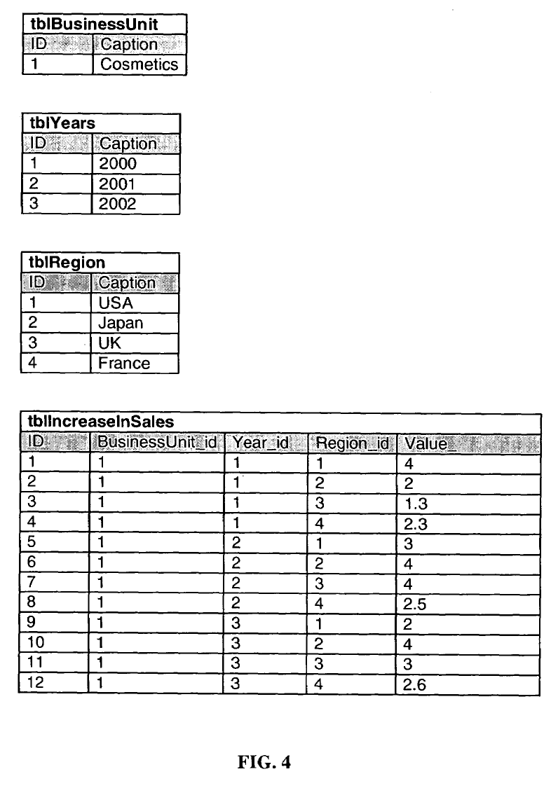

Following the initial creation of the star schema, the user may save the current spreadsheet data in the newly-created database, as shown in FIG. 4, which is the database representation of the spreadsheet of FIG. 2.

The current invention additionally allows the user to modify the values within the spreadsheet. The members of a dimension can be modified (for example, the ‘Bus. Unit’ dimension in FIG. 1 can be renamed ‘Moon and Mars’), the column or row dimensions can change in size and content (e.g. a row for ‘2003’ can be added to FIG. 2, while the rows for 2000 and 2001 can be removed), and the values for the data-items can be set.

Once the user requests to use a spreadsheet as input, for example by choosing ‘Update’ from a menu, the current invention analyzes the dimensions and data-items. First, the dimension regions are analyzed. A heuristic attempts to see if the extent of the region has changed—if non-empty cells are found at the ‘end’ of the region: for row dimension, at the bottom; column—right (for simplicity, we assume a left-to-right (Latin) orientation, however, this can easily be extended to a reverse orientation. This orientation can be deduced from the Spreadsheet Application settings or provided by the user) and non-empty cells appear in the corresponding rows (or columns) the system assumes the region was extended. If this is not the case, the user may intervene.

Alternatively, some Spreadsheet Applications (such as Microsoft Excel) provide means to name a region. This region can then change in size according to rules defined by the application. The current invention may use this mechanism to keep track of the regions extents.

Next, according to the heuristics described above, any empty cells in the rows and columns areas are ‘filled’.

For each dimension in the Parameters, Rows and Columns areas, the values presented in the spreadsheet are analyzed. If a value is new—it does not appear in the corresponding database table—the value can be added as a new ‘member’ to the dimension. Alternatively, the user may choose to use the value as an alternative name for an existing member or to rename the value and use an existing member value instead. If a new member is added, and the dimension is part of a hierarchy, the corresponding higher level dimension cell is checked, and the new member is added to its set of lower-dimension values.

Hierarchy relations are checked prior to updating the database—e.g. if ‘January’ appears as part of ‘2^{nd} Quarter’ the system may prompt the user.

The system then goes over all data-item cells. For each full cell, the cell's dimensions are determined. For dimensions appearing in the parameters area, the values are taken from that area. The values for the dimensions in the rows and column regions are determined by ‘projecting’ the cell's location onto the dimension. That is, for a row dimension, the value at the same row as the analyzed data-item is used, while for a column dimension, the value at the same column is used. For example, in FIG. 2, the dimensions of the data-item at E5 (4) can be determined as follows. Its ‘Bus. Unit’ is ‘Cosmetics’ (from the Parameters area) while the Year is ‘2001’ (projecting the cell's location E5 to the rows region we find the value in C4 to be ‘2001’), and the Country is ‘Japan’ (this time projecting to the columns region. The value at E3 is ‘Japan’).

Similarly, the dimensions for cell F5 in FIG. 3a can be calculated by projecting the cell's location into the rows and columns regions. By projecting to the rows region, we find the Region to be ‘Region 2’ (A5), while the Month is May (F3) and Quarter is Q2 (F2). Note that in this case, the value for the Quarter dimension does not appear explicitly in the spreadsheet, and is instead calculated as described in the heuristic above.

Once the dimensions for each of the cells are determined, the system can insert the values into the database, maintaining the star-schema structure. Note that a cell may be empty (does not contain any value), in which case no value is inserted into the database.

It is appreciated that certain features of the invention, which are, for clarity, described in the context of separate embodiments, may also be provided in combination in a single embodiment. Conversely, various features of the invention which are, for brevity, described in the context of a single embodiment, may also be provided separately or in any suitable subcombination.

Unless otherwise defined, all technical and scientific terms used herein have the same meanings as are commonly understood by one of ordinary skill in the art to which this invention belongs. Although methods similar or equivalent to those described herein can be used in the practice or testing of the present invention, suitable methods are described herein.

All publications, patent applications, patents, and other references mentioned herein are incorporated by reference in their entirety. In case of conflict, the patent specification, including definitions, will prevail. In addition, the materials, methods, and examples are illustrative only and not intended to be limiting.

It will be appreciated by persons skilled in the art that the present invention is not limited to what has been particularly shown and described hereinabove. Rather the scope of the present invention is defined by the appended claims and includes both combinations and subcombinations of the various features described hereinabove as well as variations and modifications thereof which would occur to persons skilled in the art upon reading the foregoing description. For example, it will be appreciated that the single matrix described in conjunction with the example of FIG. 2 may comprise a plurality of matrices within a single spreadsheet, each having its own dimensions to be identified in a similar manner to that described for a single matrix. In the case of multiple matrices within a spreadsheet, a respective plurality of dimension and data tables will be created within the relational database.

1. A method of creating a relational database schema from data represented in one or more matrix representations, comprising the steps of:
identifying dimensions of each matrix, said dimensions describing a multi-dimensional space;
identifying hierarchies within said dimensions;
identifying a data area of each matrix;
calculating a set of coordinates within said multi-dimensional space for each data member in each said data areas; and
mapping said dimensions into database tables.

2. The method according to claim 1, wherein said step of identifying dimensions is performed manually and said step of identifying a data area is performed automatically, based on said manual identification of dimensions.

3. The method according to claim 1, wherein said step of identifying a data area is performed manually and said step of identifying dimensions is performed automatically, based on said manual identification of a data area.

4. The method according to claim 1, wherein said dimensions comprise at least one parameters area, at least one rows area and at least one columns area.

5. The method according to claim 4, wherein said at least one rows area comprises a plurality of rows areas, whereby a hierarchy is automatically deduced.

6. The method according to claim 5, wherein said automatic deduction of hierarchy is based on the distance of said rows areas from the data area.

7. The method according to claim 4, wherein said at least one columns area comprises a plurality of columns areas, whereby a hierarchy is automatically deduced.

8. The method according to claim 7, wherein said automatic deduction of hierarchy is based on the distance of said columns areas from the data area.

9. The method according to claim 1, wherein empty cells of a dimension are filled automatically.

10. The method according to claim 9, wherein said empty dimension cells are automatically filled according to one of nearest neighbor, first non-empty cell to the left and color barrier.

11. The method of claim 1, wherein said database tables represent a star schema.

12. The method according to claim 1, additionally comprising the step of modifying at least one of said dimensions and said data, wherein said modification automatically updates said database.

13. The method according to claim 12, wherein said modification comprises at least one of the group consisting of: modifying a region extent, modifying a region name and modifying a data item value.

14. A system for creating a relational database schema from data represented in a matrix representation, comprising:
means for identifying dimensions of the matrix, said dimensions describing a multi-dimensional space;
means for identifying hierarchies within said dimensions;
means for identifying at least one data area of the matrix;
means for calculating a set of coordinates within said multi-dimensional space for each data member in each said data areas; and
means for mapping said dimensions into database tables.

15. The system according to claim 14, wherein said means for identifying dimensions are user interface means.

16. The system according to claim 14, wherein said means for identifying a data area are user interface means.

17. The system according to claim 14, wherein said dimensions comprise one or more parameters areas, one or more rows areas and one or more columns areas.

18. The system according to claim 14, additionally comprising means for automatically filling empty cells of a dimension.

19. The system according to claim 14, wherein said database tables represent a star schema.

20. The system according to claim 14, additionally comprising means for modifying at least one of said dimensions and said data, wherein said modification automatically updates said database.

21. The system according to claim 20, wherein said modification means comprise at least one of the group consisting of: means for modifying a region extent, means for modifying a region name and means for modifying a data item value.

22. A computer-readable medium having computer-executable instructions stored thereon which, when executed by a computer, will cause the computer to perform the method of claim 1.

23. A computer-controlled apparatus capable of performing the method of claim 1.
